(19) United States
(12) Patent Application Publication
(10) Pub. No.: US 2023/0097748 A1
(43) Pub. Date: Mar. 30, 2023

(54) GENERATING A GRAPHICAL USER INTERFACE IN A PRE-OPERATING SYSTEM BOOT ENVIRONMENT

(71) Applicant: Hewlett-Packard Development Company, L.P., Spring, TX (US)

(72) Inventors: Patrick Gibbons, Spring, TX (US); Christopher Stewart, Spring, TX (US); Charles Ricardo Staub, Porto Alegre (BR); Tadeu De Sousa Marchese, Spring, TX (US); RODRIGO WETZEL SILVEIRA, Porto Alegre (BR)

(21) Appl. No.: 17/795,479

(22) PCT Filed: Feb. 19, 2020
(86) PCT No.: PCT/US2020/018807

§ 371 Date: Jul. 26, 2022

(51) Int. Cl. G06F 9/4401; G06F 9/451

(52) U.S. Cl. CPC G06F 9/4401; G06F 9/451

(57) ABSTRACT

Examples are described herein for providing a graphical user interface (“GUI”) in a pre-operating system (“pre-OS”) boot environment. In some examples, an object-oriented hierarchy of data structures that define a plurality of GUI elements may be generated from user interface data provided by a firmware module. A plurality of bitmaps corresponding to a subset of the hierarchy of data structures may be stored, e.g., in memory for rendition on a display while the pre-OS boot environment is active. Each bitmap may portray a visual aspect of a given GUI element of the plurality of GUI elements.

### BACKGROUND

When a computing device is powered on, a boot process is performed to initialize hardware devices and runtime services. For instance, it is common for a computer, prior to loading an operating system (“OS”), to execute computer-readable instructions known as “firmware” to implement a pre-OS environment in which a user can participate in the boot process, e.g., by adjusting hardware parameters. Historically, this firmware has taken the form of a Basic Input/Output System (“BIOS”). Unified Extensible Firmware Interface (“UEFI”) is a successor to BIOS and is meant to address some of its technical shortcomings.

### BRIEF DESCRIPTION OF THE DRAWINGS

Features of the present disclosure are illustrated by way of example and not limited in the following figure(s), in which like numerals indicate like elements.

FIG. 1 is a drawing of an example environment in which selected aspects of the present disclosure may be implemented.

FIG. 2 depicts an example object-oriented hierarchy of data structures that can be generated and used to render graphical content in a pre-operating system boot environment, in accordance with various examples.

FIGS. 3A and 3B depict an example of how user interaction with a selectable display stack can alter a z-order of the selectable stack, and hence, an appearance of a corresponding GUI element.

FIG. 4 depicts an example method for practicing selected aspects of the present disclosure.

FIG. 5 depicts an example system that incorporates selected aspects of the present disclosure.

FIG. 6 depicts an example computer-readable medium that incorporates selected aspects of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Additionally, it should be understood that the elements depicted in the accompanying figures may include additional components and that some of the components described in those figures may be removed and/or modified without departing from scopes of the elements disclosed herein. It should also be understood that the elements depicted in the figures may not be drawn to scale and thus, the elements may have different sizes and/or configurations other than as shown in the figures.

Methods, systems, apparatus, computer-readable media (transitory and non-transitory), and a framework are provided for replacing text-based user interfaces currently provided in BIOS and/or UEFI-based pre-OS environments with graphical user interfaces (“GUIs”). In various examples, an object-oriented architecture may be used to generate and render selectable graphical elements instead of (or in addition to) interactive textual elements. A pre-OS environment in which the aforementioned firmware is implemented is often resource-constrained, particularly in terms of available memory.

Accordingly, the object-oriented architecture and/or its various features, such as fields and methods that are shared amongst objects, allow for generation of a GUI in a pre-OS boot environment using a relatively small memory footprint. In some examples, techniques and components described herein may augment or even replace the Text Setup Environment (“TSE”) provided by the UEFI standard.

In various examples, a firmware module (e.g., a driver) associated with as piece of hardware installed in or otherwise operably coupled with a computing device may publish form data—e.g., data indicative of configuration controls the hardware manufacturer wishes to expose to end users—to a database. Consequently, this database may be populated with form data associated with multiple different hardware devices and other data used for computer configuration and operation. These form data may be processed when a user accesses a pre-OS boot environment (e.g., by pressing a function button during the boot process, or by restarting the computing device in a special way) to provide the user with an interface that the user can navigate to interact with the various firmware forms, for instance, to configure hardware settings for a device or otherwise to configure settings under the control of the BIOS.

With techniques described herein, these form data may be parsed to generate an object-oriented hierarchy of data structures that define a plurality of GUI elements, in addition to or instead of interactive textual elements. In various examples, each data structure may include methods such as mutator methods (e.g., getter and/or setter) to manipulate variables, a selectable display stack with a z-order (i.e., an order of rendered elements along a normal of the display), and bitmap data in some examples. These various elements may in some cases be inherited in whole or in part from parent data structures.

In some examples, bitmaps corresponding to the layers of the selectable display stacks may be generated, retrieved, and/or stored in, for instance, a display buffer for rendition on a display, e.g., in an order imposed by the z-order mentioned previously. In some examples, stack of bitmaps defined by a selectable display stack may be combined using techniques such as bit block transfer, but this is not meant to be limiting.

In some examples, there may be a global z-order imposed across the entire hierarchy (which may be a global selectable display stack), and local z-orders associated with nodes of the hierarchy. For example, the object-oriented hierarchy may take the form of a tree of nodes, and the global selectable display stack may impose a global z-order across the nodes of the tree. Additionally, individual nodes of the tree may represent “sub” selectable display stacks (e.g., with their own local z-orders) that can be nested in the tree of nodes.

In some examples, a static selectable stack data structure may define a user interface (“UI”) element that is itself comprised of other Ul elements, without allowing for any dynamic modification of element z-order. An example of this is a checkbox, which includes: a string that displays the checkbox’s use; a box with outline, that is a graphical structure; and a checkmark that might or might not be displayed. Such composite Ul elements can be created with a stack of primitive elements (e.g., bitmaps) whose z-order is fixed.

GUIs rendered using techniques described herein may be operated by a user to alter any number of configuration and/or operational settings of a computing system. For example, one GUI form generated using techniques described herein may facilitate configuration of various configuration options such as clock speed, hard drive allocations, and so forth. Another GUI form may facilitate on-demand wireless network setup. Another GUI form (e.g., generated using data provided by a device driver) may facilitate configuration of a particular hardware device’s settings. And so on.

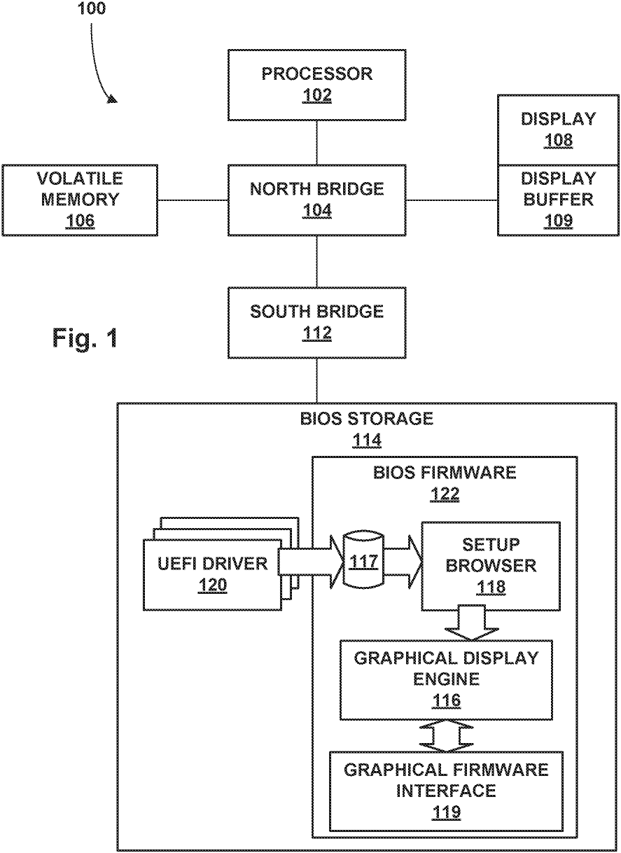

FIG. 1 shows a system 100 employing a graphical display engine 116 configured with selected aspects of the present disclosure. The system 100 includes a processor 102, a north bridge 104, and a south bridge 112. Various examples may implement north and south bridges 104, 112 as separate components or as a single component. The system 100 also includes volatile memory 106, which in some examples takes the form of Dynamic Random Access Memory (“DRAM”); however, Static Random Access Memory (“SRAM”), or other suitable random access memory technology may also be used.

A display 108 provides visual information to a user. A liquid crystal display (“LCD”), cathode ray tube (“CRT”) display, a plasma display, an organic light emitting diode (“OLED”) display, an electro-luminescent display, a projection display, or other display technology used to display text and graphics for a user may be employed. In various examples, content that is rendered on display may be content that is stored in a display buffer 109, e.g., by processor 102.

BIOS storage 114 may take the form of a BIOS firmware or 122 for booting the system 100 and transferring control to an operating system (not depicted). The term “BIOS” as used herein is intended to encompass a variety of boot, initialization, and operating system start-up programs known to those of skill in the art, including such programs based on the UEFI standard.

BIOS storage 114 may include memory device(s) in which the BIOS firmware 122 is stored, and may be implemented as a read-only memory (“ROM”) having its contents fixed at manufacture, a FLASH memory whose contents may be modified post-manufacture, or other type of non-volatile memory suitable for storing BIOS, for example, programmable ROM (“PROM”), electrically erasable PROM (“EEPROM”), magnetoresistive random access memory (“MRAM”), or ferroelectric memory. Some examples execute the BIOS firmware 122 directly from BIOS Storage 114. Other examples copy all or a portion of the BIOS firmware 122 from BIOS Storage 114 to volatile memory 1 06 for execution.

BIOS firmware 122, such as that stored in BIOS Storage 114, may include a BIOS setup program that allows a user of the system 100 to access and modify various operational settings of the system 100. In some examples, the setup program may initiated by depressing a button, for example <F1 0> or <DELETE>, prior to the operating system being loaded.

A plurality of UEFI drivers 120 are also provided. These UEFI drivers 120 may include drivers that control devices and drivers that execute logic that is device-independent. For example, some device-independent UEFI drivers 120 implement industry standards, such as Universal Serial Bus (“USB”), and provide hooks where a specific device-dependent driver can provide an implementation. Other UEFI drivers 120 control firmware settings that might not impact the specific execution of any device. Put another way, there are device drivers that directly control hardware, device drivers that indirectly control hardware, and drivers that do not control hardware at all (though they may make use of devices, as in a graphics package that manipulates bitmaps and then calls a device driver to display those bitmaps on a display device).

The BIOS firmware 122 of system 100 includes a “setup” browser 118 (also referred to as a “forms browser”) that generates and/or provides, for rendition on display 108, UI elements that are interactive to modify the aforementioned configuration and/or operational settings of system 100. In some examples, such as that depicted in FIG. 1, setup browser 118 has access to a Human Interface Infrastructure (“HII”) database 117 (other types of databases are contemplated; HII is defined in the UEFI standard). HII database 117 may serve as a repository of form, string, image, and/or font data (collectively, “forms data”) for a pre-operating system (“pre-OS”) boot environment. In some such examples, setup browser 118 may read the content of HII database 117 and interpret the forms data contained therein for presentation to the user. In many cases, setup browser 118 may also receive user input and allow for changes to be saved into non-volatile storage.

In some examples, UEFI driver(s) 120 publish or export their respective forms data to HII database 117 during the boot process. This data may be usable, e.g., by setup browser 118, to render UI element(s) on display 108 (or audibly as the case may be). As noted previously, without the use of techniques described herein, these UIelements may be rendered by setup browser 118 as textual interfaces.

Accordingly, graphical display engine 116 may practice selected aspects of the present disclosure to generate (or help generate) a GUI in a pre-OS boot environment, while maintaining a relatively small memory footprint suitable for use in the pre-OS boot environment. For example, graphical display engine 116 may generate, from UI data published by UEFI driver(s) 120 to HII database 117, an object-oriented hierarchy of data structures that define a plurality of GUI elements. Graphical display engine 116 may then store (or cause to be stored), e.g., in a display or graphics buffer 109, for rendition on display 108 while the pre-OS boot environment is active, a plurality of bitmaps corresponding to a subset of the plurality of data structures. Each bitmap may portray a visual aspect of a given GUI element of the plurality of GUI elements, such as an outline of a check box, the check itself, an outline of a radio button box, or other components of interactive GUI elements.

In some examples, rather than storing the plurality of bitmaps itself, graphical display engine 116 may provide data indicative of the object-oriented hierarchy of data structures to a graphical firmware interface 119, e.g., using a graphics manipulation data exchange protocol. Graphical firmware interface 119 may retrieve and/or generate the bitmaps based on the data structures. In some such examples, then, graphical firmware interface 119 may provide a “look-and-feel” to GUI elements, e.g., independently of graphical display engine 116. In other examples, graphical display engine 116 and graphical firmware interface 119 may be integrated into a single component.

In some examples, each data structure of the hierarchy of data structures may include a selectable display stack that is used to generate a corresponding stack of bitmaps from the plurality of bitmaps. For example, the selectable display stack for a given data structure may have a z-order that is imposed on a subset of the plurality of bitmaps that is selected for use with the given data structure. As used herein, the terms “front” and “forward,” when used in the context of z-order, will refer to positions and/or movement along a normal of display 108 towards the user. The terms “back” and “backward,” when used in the context of z-order, will refer to positions and/or movement along the normal of display 108 away from the user, e.g., into display 108.

When rendered on display 108, in some examples, the stack of bitmaps for the given selectable element may be combined in accordance with the z-order into what appears from the user’s perspective as an interactive GUI element. In some such examples, the multiple bitmaps may be combined using bit block transfer. In some such examples, upon rendition of the stack of bitmaps on display 108, the stack of bitmaps may be interacted with by a user to alter the z-order of the selectable display stack, e.g., so that a different bitmap moves to the front and/or the previous front bitmap moves backward. In some examples, a stack of bitmaps forming an interactive GUI element may be selectable as an atomic element for placement onto another stack of bitmaps. In other words, an internal z-order of the stack of bitmaps may be unaltered by the selection.

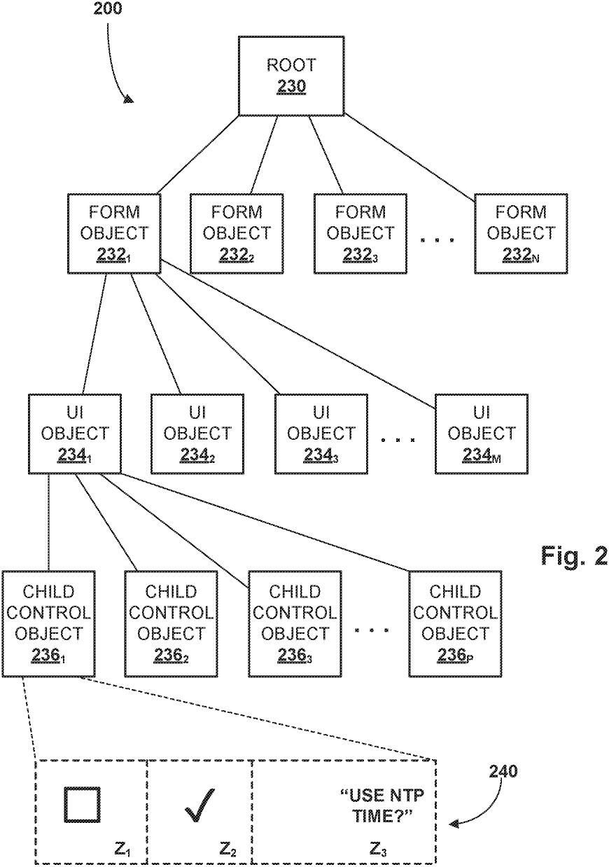

FIG. 2 depicts an example object-oriented hierarchy 200 of data structures, “objects,” or “nodes,” that define a plurality of GUI elements. Hierarchy 200 may be assembled, e.g., by graphical display engine 116, using techniques described herein. Once assembled, hierarchy 200 may be used by graphical display engine 116 in accordance with various examples herein to cause graphical content to be rendered on display 108 in a pre-OS environment. Each object may include its own images, state, and various properties, methods and property accessor methods (e.g., getters and setters). If an object has children, the object may include the list of children and a selectable display stack. In some examples, each selectable display stack may include a node for each child’s current image and a node for its own background/canvas image.

At the top of hierarchy is a root object 230. Root object 230 may serve as an overall display management object. In some implementations, UI events such as button presses, mouse clicks, and touches (if display 108 is a touchscreen) may be collected at root object 230. These UI events may then be passed down hierarchy 200, e.g., along a path of objects that are currently in focus or “active.” For objects to be “in focus” or “active” means that bitmaps associated with those objects are currently visible to and/or interactive by a user.

Below root object 230 are a plurality of form objects 232_{1-N}. In some examples, each form object 232 may be created based on data from a single firmware driver, although this is not always the case. Each form object 232 may correspond generally to a particular form that, when rendered by graphical display engine 116, can be operated by a user to adjust various logically and/or semantically-related configuration and/or operational settings of system 100 in FIG. 1.

Below first form object 232₁ are a plurality of UI objects 234_{1-M} (which are “children” of first form object 232₁). It should be understood that other form objects 232_{2-N} may also include their own UI objects 234, but, for the sake of simplicity and brevity, those are not depicted in FIG. 2. Each UI object 234 may represent a UI control object that, in some examples, represents an HII configuration option (or “question” in UEFI parlance). Thus, each UI object 234 may correspond to a graphical UI control such as a button, check box, enumerated list, ordered list, text label, text edit box, radio button(s), etc. In some examples, UI objects 234 may also represent various dialogs and/or pop-up windows or notifications.

Below first UI object 234₁ are a plurality of child control objects 236_{1-P}. It should be understood that other UI objects 234_{2-M} may or may not also include their own child control objects 236, but, for the sake of simplicity and brevity, those are not depicted in FIG. 2. Child control objects 236_{1-P} may, based on user interaction with GUI element(s), control aspects of GUI elements such as radio button selections, check box selections, etc.

In some examples, hierarchy 200 may operate as follows. Each object of hierarchy 200 may inherit a common base object—namely, root object 230. Root object 230 may implement a base interface with various object methods that are passed down hierarchy 200. Consequently, each parent object is able to call the base interface on their children object(s). In some examples, objects may be commanded by their parents to perform various actions, such as change states, change properties, and so forth.

When an object changes its state (e.g., from idle to highlighted), in many cases the object will update its appearance. This may be accomplished in some examples by calling an “image update” function on the object’s selectable stack of bitmap images. In some such examples, the object’s parent may then call a “render” function for the selectable stack of bitmap images. The render function may handle rendering a composition of all bitmap images of the selectable stack, e.g., using bit block transfer to combine and/or superimpose various bitmap images (or elements thereof) with other bitmap images. In some examples, the render function may compose the bitmaps in the z-order of the selectable stack. Depending on a depth of hierarchy 200, each parent may, in turn (e.g., from the bottom up), call its render function to ultimately build the full image composition. In other words, a logical stack-of-stacks is formed that naturally renders a composite image without each object having knowledge of what is going on at lower levels.

An example selectable stack 240 of bitmaps is depicted in FIG. 2 as part of first child control object 236₁. In this example, first child control object 236₁ represents a check box, but similar techniques may be applied with other types of GUI elements. Selectable stack 240 includes a first bitmap image in a Z₁ position that includes a box, a second bitmap image in a Z₂ position that includes a check designed to fit within the aforementioned box, and a string in a Z₃ position that is meant to be rendered alongside the checkbox to indicate its purpose. In this example, the checkbox is selectable to toggle between a first state (checked) in which system 100 relies on network time protocol (“NTP”) to set an internal clock, and a second state (unchecked) in which system does not rely on NTP.

In the current z-order, with lower z-positions being presented in “front” of larger z-positions, the checkbox associated with first child control objet 236₁ would be rendered with the blank box on top (Z₁), followed by the check underneath (Z₂). In other words, the check would be concealed by the blank box, and what the user would see is an unchecked box. The string (“USE NTP TIME?”) element may always be visible, e.g., by virtue of its being right-justified in FIG. 2, and in some cases may occupy the Z₃ position (or another position further back).

In some examples, UI events such as button presses, mouse clicks, and/or touches may be collected at root object 230. Root object 230 may pass an event down hierarchy 200 along a path of objects that are currently in focus. A leaf-most object that has no active child object may process the event. So for example, first form object 232₁ might be the leaf-most object that is active. Suppose a down-arrow button event is captured at root object 230. Root object 230 would pass this event to first form object 232₁. Based on this event, first form object 232₁ may move a highlight from a current child (e.g., first UI object 234₁) to a next UI object (e.g., second UI object 234₂) that is capable of being highlighted.

Suppose the “enter” or “return” button is pressed next. First form object 232₁ may activate and give focus to the highlighted child—in this example, second Ul object 234₂. In some examples, the current child object is always on the top of the selectable display stack, whether the z-order matters or not. If second Ul object 234₂ is a type of object that keeps focus (e.g., a radio button control), then the next UI event (e.g., button press) captured at root object 230 would pass through first form object 232₁ to second UI object 234₂ (e.g., radio button control) for processing. Notably, first form object 232₁ doesn’t need to know anything about how its children behave. This enables minimization and/or elimination of any sort of “main event loop” source code, reducing the memory footprint of graphical display engine 116. Some UI objects 234, such as a check box, do not keep focus. Accordingly, when they are activated, these objects perform their functions but do not change their state to “activated.” As a result, UI events may not be passed down to them.

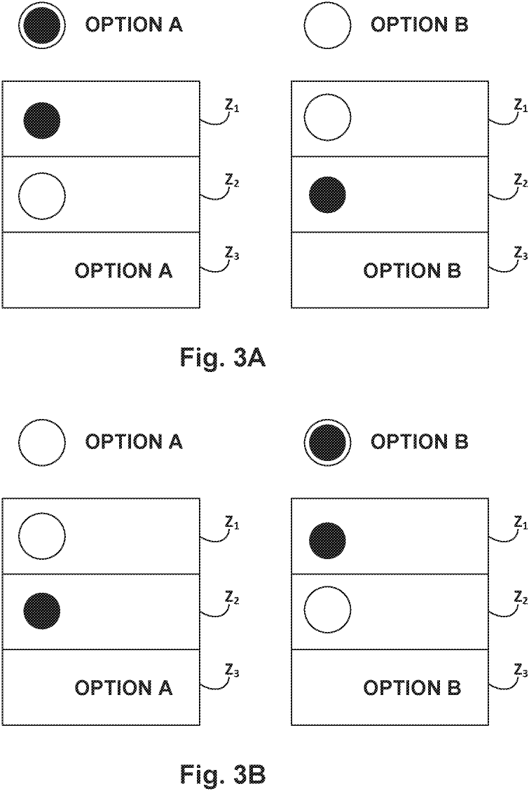

FIGS. 3A-B demonstrate one example of a GUI element in the form of a radio button selection interface, and how a z-order of bitmaps used to render that interface may be altered, e.g., in response to user selection. There are two options: Option A and Option B; selection of one option causes the other option to be unselected.

In FIG. 3A, Option A is selected and Option B is not selected. Depicted below these options are z-ordered arrays of bitmaps that are used to construct these GUI elements. Because Option A is selected, a black dot bitmap is at position Z₁ (e.g., the front visible to the user). A blank circle that surrounds the block dot is at position Z₂, and the “Option A” text is at position Z₃ in the back (offset from the other data so that it is always visible). Thus, the black dot will be rendered on top of (and centered within) the blank circle to indicate a selected radio button, and the “Option A” text will be visible to the right. The opposite is true for Option B.

FIG. 3B demonstrates what happens if the user selects Option B. It can be seen from the z-ordered arrays of bitmaps at bottom of FIG. 3B that for Option A, the black dot is now in position Z₂, behind the blank circle in position Z₁. Consequently, when this array is rendered, the block dot will not be visible to the user, which will indicate to the user that Option A is no longer selected. The converse is true for Option B. In particular, the black dot now occupies position Z₁ of the Option B z-ordered bitmap array, which will result in the block dot being visible to the user (to indicate selection of Option B).

With a given hierarchy of object-oriented data structures there are likely to be multiple instances of the same type of GUI element. The bitmaps used for each constituent component of those GUI elements can be reused across multiple GUI elements, which conserves memory. For example, the same black dot and blank circle bitmaps of FIGS. 3A-B may be used across both Options A and B, as well as for any other radio button GUI element.

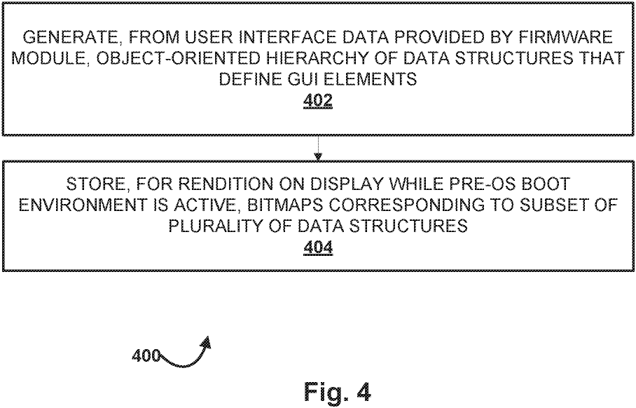

FIG. 4 illustrates a flowchart of an example method 400 for practicing selected aspects of the present disclosure. The operations of FIG. 4 can be performed by a processor, such as processor 102 executing instructions in BIOS storage 114. For convenience, operations of method 400 will be described as being performed by a system configured with selected aspects of the present disclosure. This system may include, for instance, graphical display engine 116. Other implementations may include additional operations than those illustrated in FIG. 4, may perform operation(s) of FIG. 4 in a different order and/or in parallel, and/or may omit operation(s) of FIG. 4.

At block 402, the system may generate, from user interface data provided by a firmware module (e.g., 120), an object-oriented hierarchy of data structures that define a plurality of GUI elements. One example of such a hierarchy was depicted in FIG. 2 at 200. In some examples, the user interface data may be binary data provided by setup browser 118, and may take the form of opcodes (e.g., portions of machine language instructions) in various formats, such as internal forms representation (“IFR”). IFR data may be compiled from visual forms representation (“VFR”) data that is written into source code underlying UEFI drivers 120.

At block 404, the system may store, in memory such as display buffer 109, for rendition on display 108 while a pre-OS boot environment is active, a plurality of bitmaps corresponding to a subset of the plurality of data structures. As noted previously, each bitmap may portray a visual aspect of a given GUI element of the plurality of GUI elements.

In some examples, the storing of block 404 may include assembling the plurality of bitmap representations relative to each other horizontally and vertically in accordance with the hierarchy. For example, the distinct forms corresponding to form objects 232_{1-N} may be rendered in some examples as user-selectable tabs, wherein selection of a given form tab causes that form to be rendered in front of forms corresponding to other form objects. UI objects 234 below (i.e. that are children of) a particular form object 232 may, when the form object is activated, be rendered in a horizontal and/or vertical arrangement that is appropriate for the type of UI element. For example, radio button options are often rendered as a vertical or horizontal list.

In various examples, the system may then render, e.g., on display 108, the content of the display buffer that was populated at block 404. A user may then be able to interact with the plurality of GUI elements, e.g., using a keyboard, mouse, or, if display 108 is a touchscreen, with touch.

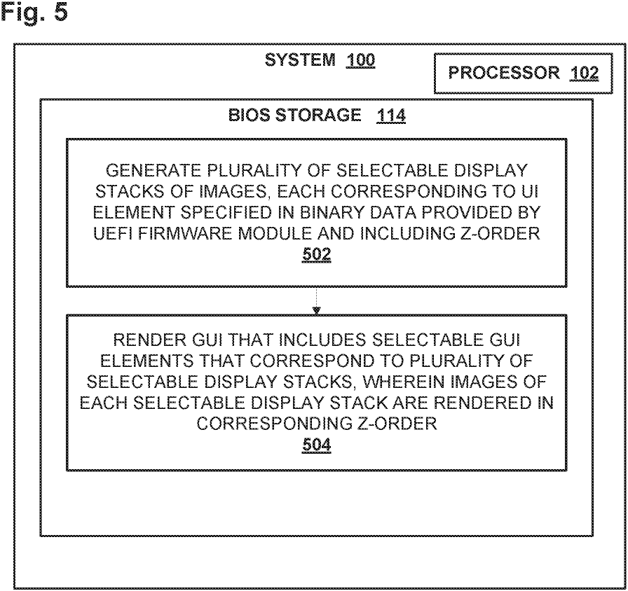

FIG. 5 depicts an example system (e.g., 100) that incorporates selected aspects of the present disclosure. In this example, the system 100 includes computer-readable medium in the form of BIOS storage 114, but it could also take the form of volatile memory 106. Stored in BIOS storage 114 are instructions 502-504 that are executable by processor 102 to carry out selected aspects of the present disclosure.

Instruction 502 causes processor 102 to generate a plurality of selectable display stacks of images. In various examples, each selectable display stack may correspond to a UI element specified in binary data provided by, for instance, a UEFI firmware module. In some examples, each selectable display stack may include a z-order to be imposed on the images of the selectable display stack.

Instruction 505 causes processor 102 to render, e.g., on display 108, a GUI that includes a plurality of selectable GUI elements that correspond to the plurality of selectable display stacks. In various examples, images of each selectable display stack may be rendered on the display in the corresponding z-order.

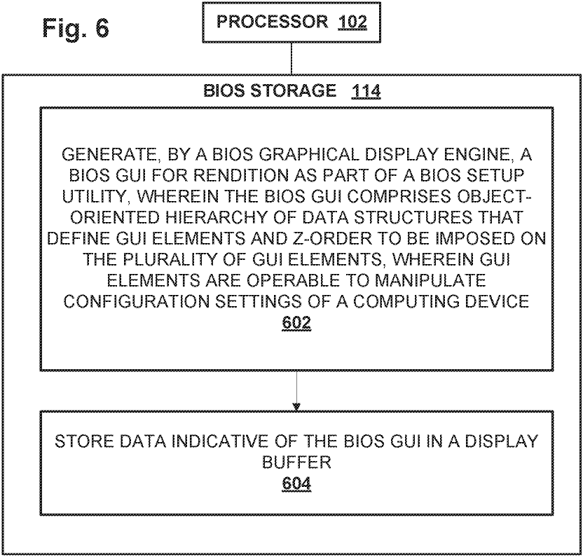

FIG. 6 depicts an example computer-readable medium that incorporates selected aspects of the present disclosure. In this example the computer-readable medium takes the form of BIOS storage 114, but it could also take the form of volatile memory 106. In various examples, the computer-readable medium can be transitory or non-transitory. Stored in BIOS storage 114 are instructions 602-604 that are executable by processor 102 to carry out selected aspects of the present disclosure.

Instruction 602 may cause processor 102 to generate, e.g., by way of BIOS graphical display engine 116, a BIOS GUI for rendition as part of a BIOS setup utility. In various examples, the BIOS GUI may include an object-oriented hierarchy of data structures that define a plurality of GUI elements and a z-order to be imposed on the plurality of GUI elements. In some examples, the GUI elements may be interacted with, e.g., by a user operating an input device such as a keyboard, mouse, or touchscreen, to manipulate hardware configuration settings of a computing device that hosts the processor. Instruction 604 may cause processor 102 to store data indicative of the BIOS GUI in a display buffer, which can be used to render content on display 108.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What is claimed is:

1. A method for generating a graphical user interface (“GUI”) in a pre-operating system (“pre-OS”) boot environment, the method implemented using a processor and comprising:
generating, from user interface data provided by a firmware module, an object-oriented hierarchy of data structures that define a plurality of GUI elements; and
storing, in memory for rendition on a display while the pre-OS boot environment is active, a plurality of bitmaps corresponding to a subset of the hierarchy of data structures, wherein each bitmap portrays a visual aspect of a given GUI element of the plurality of GUI elements.

2. The method of claim 1, wherein a given data structure of the hierarchy of data structures comprises a selectable display stack that is used to generate a corresponding stack of bitmaps from the plurality of bitmaps, wherein the selectable display stack has a z-order that is imposed on the stack of bitmaps.

3. The method of claim 2, wherein the stack of bitmaps are combined using bit block transfer.

4. The method of claim 2, wherein the stack of bitmaps, upon rendition on the display, are selectable to alter the z-order of the selectable display stack.

5. The method of claim 2, wherein the stack of bitmaps, upon rendition on the display, are selectable as an atomic element for placement onto another stack of bitmaps, wherein an internal z-order of the stack of bitmaps is unaltered by the selection.

6. The method of claim 1, wherein the storing includes assembling the plurality of bitmap representations relative to each other horizontally and vertically in accordance with the hierarchy.

7. The method of claim 1, wherein a given data structure of the hierarchy of data structures includes one or both of a getter method and setter method, and a bitmap.

8. The method of claim 1, wherein the pre-OS boot environment comprises a unified extensible firmware interface (“UEFI”) environment.

9. A system comprising:
a processor; and
computer-readable memory comprising instructions that, in response to execution of the instructions by the processor, cause the processor to implement a graphical display engine for a basic input/output system (“BIOS”), the graphical display engine to:
generate a plurality of selectable display stacks of images, wherein each selectable display stack corresponds to a user interface element specified in binary data provided by a unified extensible firmware interface (“UEFI”) firmware module and includes a z-order to be imposed on the images of the selectable display stack; and
render a graphical user interface (“GUI”) that includes a plurality of selectable GUI elements that correspond to the plurality of selectable display stacks, wherein images of each selectable display stack are rendered on the display in the corresponding z-order.

10. The system of claim 9, wherein the plurality of selectable display stacks comprise a tree of object-oriented data structures in which some of the data structures inherit methods or data from higher-up data structures in the tree.

11. The system of claim 9, wherein the binary data comprises internal forms representation (“IFR”) data that was compiled from visual forms representation (“VFR”) data.

12. A non-transitory computer-readable medium comprising instructions that, in response to execution of the instructions by a processor, cause the processor to:
generate, by a basic input/output system (“BIOS”) graphical display engine, a BIOS graphical user interface (“GUI”) for rendition as part of a BIOS setup utility, wherein the BIOS GUI comprises an object-oriented hierarchy of data structures that define a plurality of GUI elements and a z-order to be imposed on the plurality of GUI elements, wherein the GUI elements are interactive to manipulate hardware configuration settings of a computing device that hosts the processor; and
store data indicative of the BIOS GUI in a display buffer.

13. The computer-readable medium of claim 12, wherein the BIOS graphical display engine generates the object-oriented hierarchy of data structures based on binary opcodes provided by a BIOS firmware module.

14. The computer-readable medium of claim 13, wherein the binary opcodes comprise internal forms representation (“IRF”) data.

15. The computer-readable medium of claim 12, wherein a given data structure of the object-oriented hierarchy of data structures comprises a selectable display stack that is used to generate a corresponding stack of bitmaps, wherein the selectable display stack is associated with an additional z-order that is imposed on the stack of bitmaps.
